(19) United States
(12) Patent Application Publication
(10) Pub. No.: US 2019/0297711 A1
(43) Pub. Date: Sep. 26, 2019

(54) A DEVICE, SYSTEM AND METHOD FOR CONTROLLING OPERATION OF LIGHTING UNITS

(71) Applicant: WIZCONNECTED COMPANY LIMITED, North Point (HK)

(72) Inventors: Jean-Philippe GAL, North Point (HK); Jerome LEROY, North Point (HK)

(21) Appl. No.: 15/550,593

(22) PCT Filed: Feb. 23, 2017
(86) PCT No.: PCT/CN2017/074600

§ 371 Date: Aug. 11, 2017

(30) Foreign Application Priority Data
Dec. 12, 2016 (HK) 16114125.1

(51) Int. Cl. H05B 37/02; H05B 33/08

(52) U.S. Cl. CPC H05B 37/0272; H05B 33/0857

(57) ABSTRACT

A device for controlling operation of lighting units including: an image capture module for capturing image data representing an output lighting characteristic of at least a first lighting unit; at least one data store module operably connected with the image capture module for storing the captured image data and an associated lighting unit settings data, said associated lighting unit settings data being indicative of lighting unit settings of the first lighting unit for producing the output lighting characteristic of the first lighting unit represented by the captured image data; an electronic display module for displaying an image of the output lighting characteristic of the at least one first lighting unit represented by the captured image data; an input module for receiving an input indicative of a selection relating to the image of the output lighting characteristic of the at least one first lighting unit displayed on the electronic display module, whereby responsive to the selection, a controller module is configured for operating a second lighting unit with reference to the associated lighting unit settings data whereby the second lighting unit substantially outputs the output lighting characteristic of the first lighting unit represented by the captured image data.

### BACKGROUND OF THE DISCLOSURE

### 1. Field of the Disclosure

The present invention relates to devices, systems and methods for controlling operation of lighting units.

### 2. Description of the Related Art

Modern day lighting devices such as lamps, luminaires and the like may be controllable by a user to output a desired lighting characteristic. For instance, the user may be able to manipulate a control interface to adjust the colour temperature, brightness, dimming behavior and other light emission characteristics to achieve the output desired lighting characteristic. One problem with the use of such lighting devices is that a user may not know how to optimally adjust the operational settings (e.g. colour, brightness, dimming, etc.) of the lighting device to achieve a particular output lighting characteristic pleasing to the user. Moreover, even when the user has suitably adjusted the operational settings of the lighting unit, it may be difficult for the user to quickly and easily remember how to replicate the same operational settings on the same lighting device or a different lighting device again in future. Accordingly, there is a perceived need to improve the manner in which users are able to control operation of lighting devices in view of such problems.

### SUMMARY OF THE DISCLOSURE

The present invention seeks to alleviate at least one of the above-described problems.

The present invention may involve several broad forms. Embodiments of the present invention may include one or any combination of the different broad forms herein described.

In a first broad form, the present invention provides a device for controlling operation of lighting units, said device including:

an image capture module for capturing image data representing an output lighting characteristic of at least a first lighting unit;

at least one data store module operably connected with the image capture module for storing the captured image data and an associated lighting unit settings data, said associated lighting unit settings data being indicative of lighting unit settings of the first lighting unit for producing the output lighting characteristic of the first lighting unit represented by the captured image data;

an electronic display module for displaying an image of the output lighting characteristic of the at least one first lighting unit represented by the captured image data;

an input module for receiving an input indicative of a selection relating to the image of the output lighting characteristic of the at least one first lighting unit displayed on the electronic display module, whereby responsive to the selection, a controller module is configured for operating a second lighting unit with reference to the associated lighting unit settings data whereby the second lighting unit substantially outputs the output lighting characteristic of the first lighting unit represented by the captured image data.

Typically, the image may include either a static image or video images.

Typically, the first and second lighting units may be the same.

Preferably, the device may include a mobile electronic device.

Also preferably, the mobile electronic device may include at least one of a mobile smartphone, a table and a portable computer.

Preferably, the electronic display module may be configured to display a plurality of images of captured output lighting characteristics of first lighting units represented by a plurality of corresponding captured images datas, said input module being configured for receiving an input indicative of a selection relating to any one of the plurality of images displayed on the electronic display module, whereby responsive to the selection, the controller module is configured for operating the second lighting unit with reference to lighting unit settings data associated with image data corresponding to the selected image, whereby the second lighting unit substantially outputs the output lighting characteristic of the first lighting unit represented by the image data corresponding to the selected image.

Preferably, the plurality of corresponding image datas representing the plurality of corresponding images of captured output lighting characteristics of first lighting units, may be synchronised across multiple electronic devices via a communication network.

Preferably, the controller module may be configured for operating the second lighting unit via a wireless communication network.

Also preferably, the wireless communication network may include a Wi-Fi protocol compatible network.

Preferably, the input module may be configured to allow a user to customise information displayable with the image on the electronic display module, the information including a title of the image.

Preferably, the output lighting characteristic of at least a first lighting unit may include at least one of:

i. a colour characteristic;

ii. a brightness characteristic;

iii. a white light colour temperature;

iv. an infrared radiation characteristic; and

v. a timing characteristic for the output of at least one of (i)-(iv).

Preferably, the device may be configured for downloading a computer program in to the at least one data store, said computer program being executable by the controller module to operate the device in accordance with this broad form of the present invention.

In a second broad form, the present invention provides a method of controlling operation of lighting units, said method including steps of:

(i) capturing via an image capture module, image data representing an output lighting characteristic of at least a first lighting unit;

(ii) storing in at least one data store module, the captured image data and an associated lighting unit settings data, said associated lighting unit settings data being indicative of lighting unit settings of the first lighting unit for producing the output lighting characteristic of the first lighting unit represented by the captured image data;

(iii) displaying via an electronic display module, an image of the output lighting characteristic of the at least one first lighting unit represented by the captured image data; and

(iv) receiving via an input module, an input indicative of a selection relating to the image of the output lighting characteristic of the at least one first lighting unit displayed on the electronic display module, whereby responsive to the selection, a controller module is configured for operating a second lighting unit with reference to the associated lighting unit settings data whereby the second lighting unit substantially outputs the output lighting characteristic of the first lighting unit represented by the captured image data.

Typically, the image may include either a static image or video images.

Typically, the first and second lighting units may be the same.

Preferably, the method may be performed using a mobile electronic device.

Also preferably, the mobile electronic device may include at least one of a mobile smartphone, a table and a portable computer.

Preferably, the electronic display module may be configured to display a plurality of images of captured output lighting characteristics of first lighting units represented by a plurality of corresponding captured images datas, said input module being configured for receiving an input indicative of a selection relating to any one of the plurality of images displayed on the electronic display module, whereby responsive to the selection, the controller module is configured for operating the second lighting unit with reference to lighting unit settings data associated with image data corresponding to the selected image, whereby the second lighting unit substantially outputs the output lighting characteristic of the first lighting unit represented by the image data corresponding to the selected image.

Preferably, the plurality of corresponding image datas representing the plurality of corresponding images of captured output lighting characteristics of first lighting units, are synchronised across multiple electronic devices via a communication network.

Preferably, the controller module may be configured for operating the second lighting unit via a wireless communication network.

Also preferably, the wireless communication network may include a Wi-Fi protocol compatible network.

Preferably, the input module may be configured to allow a user to customise information displayable with the image on the electronic display module, the information including a title of the image.

Preferably, the output lighting characteristic of the at least a first lighting unit may include at least one of:

i. a colour characteristic;

ii. a brightness characteristic;

iii. a white light colour temperature;

iv. an infrared radiation characteristic; and

v. a timing characteristic for the output of at least one of (i)-(iv).

Preferably, the mobile electronic device may be configured for downloading a computer program in to the at least one data store, said computer program being executable by the controller module to operate the device in accordance with any one of method steps described herein.

In a third broad form, the present invention provides a system for controlling operation of lighting units, the system including:

an image capture module for capturing image data representing an output lighting characteristic of at least a first lighting unit;

at least one data store module operably connected with the image capture module for storing the captured image data and an associated lighting unit settings data, said associated lighting unit settings data being indicative of lighting unit settings of the first lighting unit for producing the output lighting characteristic of the first lighting unit represented by the captured image data;

an electronic display module for displaying an image of the output lighting characteristic of the at least one first lighting unit represented by the captured image data;

an input module for receiving an input indicative of a selection relating to the image of the output lighting characteristic of the at least one first lighting unit displayed on the electronic display module, whereby responsive to the selection, a controller module is configured for operating a second lighting unit with reference to the associated lighting unit settings data whereby the second lighting unit substantially outputs the output lighting characteristic of the first lighting unit represented by the captured image data.

Typically, the image may include either a static image or video images.

Typically, the first and second lighting units may be the same.

Typically the system may be at least partially embodied in a mobile electronic device.

Preferably, the mobile electronic device may include at least one of a mobile smartphone, a table and a portable computer.

Preferably, the electronic display module may be configured to display a plurality of images of captured output lighting characteristics of first lighting units represented by a plurality of corresponding captured images datas, said input module being configured for receiving an input indicative of selection of any one of the plurality of images displayed on the electronic display module, whereby responsive to selection of the image, the controller module is configured for operating the second lighting unit with reference to lighting unit settings data associated with image data corresponding to the selected image, whereby the second lighting unit substantially outputs the output lighting characteristic of the first lighting unit represented by the image data corresponding to the selected image.

Preferably, the plurality of corresponding image datas representing the plurality of corresponding images of captured output lighting characteristics of first lighting units, may be synchronised across multiple electronic systems or devices via a communication network.

Preferably, the controller module may be configured for operating the second lighting unit via a wireless communication network.

Preferably, the wireless communication network may include a Wi-Fi protocol compatible network.

Preferably, the input module may be configured to allow a user to customise information displayable with the image on the electronic display module, the information including a title of the image.

Preferably, the output lighting characteristic of at least a first lighting unit may include at least one of:

i. a colour characteristic;

ii. a brightness characteristic;

iii. a white light colour temperature;

iv. an infrared radiation characteristic; and

v. a timing characteristic for the output of at least one of (i)-(iv).

Preferably, the system may be configured for downloading a computer program in to the at least one data store, said computer program being executable by the controller module to operate the system in accordance with this broad form of the present invention.

It will be apparent that the broad forms of the present invention may assist in providing relatively fast and easy way in which a user may select a particular output lighting characteristic of a lighting unit to replicate at a future time to the same lighting unit, or, to a separate second lighting unit. This obviates the need for the user to have to remember and manually apply certain lighting settings to a lighting unit to achieve the desired output lighting characteristic, as the user may simply select the image of the desired output lighting characteristic displayed on a mobile electronic device in order to initiate replication of the output lighting characteristic on to the same of a different lighting unit.

### BRIEF DESCRIPTION OF THE DRAWINGS

The present invention will become more fully understood from the following detailed description of a preferred but non-limiting embodiment thereof, described in connection with the accompanying drawings, wherein:

FIG. 1 shows a flow-diagram of method steps in accordance with one embodiment of the present invention;

FIG. 2 shows a functional block diagram of a lighting unit used in accordance with an embodiment of the present invention;

FIG. 3 shows a functional block diagram of a mobile electronic device serving as the electronic display module and user input interface in accordance with an embodiment of the present invention; and

FIG. 4 depicts an example layout of a lighting control system in accordance with an embodiment of the present invention.

### DETAILED DESCRIPTION OF THE PREFERRED EMBODIMENTS

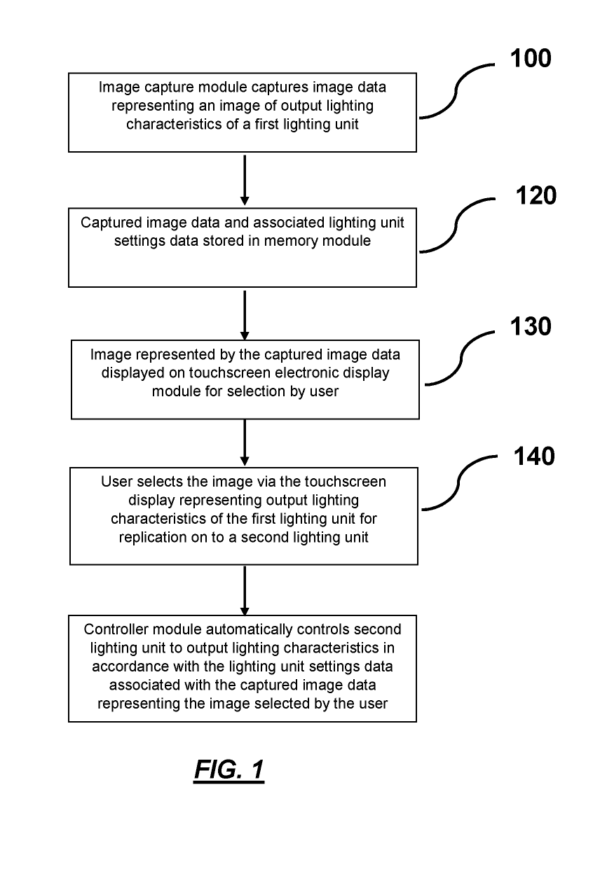

Preferred embodiments of the present invention will now be described with reference to the drawings FIGS. 1 to 4.

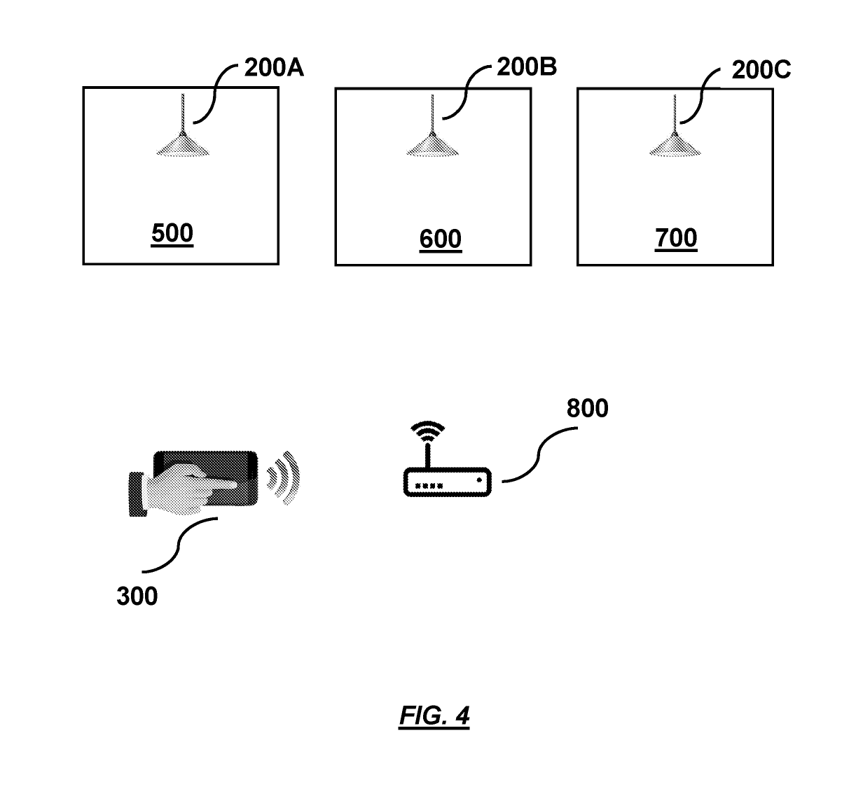

Referring to FIG. 4, a system is shown whereby a user may relatively quickly and easily operate various lighting units (200A,200B,200C) installed in various rooms (500,600,700) of a building so that such lighting units (200A,200B,200C) may output lighting characteristics that are desired by the user.

In this embodiment, at least some of the functional components of the system are integrally embodied in a single mobile electronic device (300) such as a smartphone, a tablet device or a portable computer, although it would be appreciated that in alternate embodiments, the functional components of the system may be embodied in a relatively more distributed architecture whereby such functional components may be comprised by separate component devices operably connected together via a communication network, such as the Internet or a home or office network. The system includes an image capture module (350), such as a digital camera, for capturing image data representing an output lighting characteristic of a first lighting unit (200A), a data store module (320) operably connected with the image capture module (350) for storing the captured image data and an associated lighting unit settings data. The associated lighting unit settings data is indicative of lighting unit settings of the first lighting unit (200A) for producing the output lighting characteristic of the first lighting unit (200A) represented by the captured image data.

The system further includes a touchscreen electronic display module (340) which functions as both a display for displaying an image of the output lighting characteristic of the first lighting unit (200A) represented by the captured image data, and, serves as an input module (340) for receiving various a user inputs for controlling operation of the lighting units. It is of course possible in alternate embodiments for the input module to be a separate input device such as a physical keypad, touchpad or mouse type device interface. In this embodiment, the user inputs entered via the touchscreen electronic display module (340) may represent a variety of input control instructions such as for instance (i) user selection of specific lighting characteristics of the first lighting unit (200A) that the user wishes to be emitted by the first lighting unit (200A), (ii) user selection of the captured image of the output lighting characteristic of the first lighting unit (200A) displayed on the touchscreen electronic display module (340) which the user wishes to replicate by a second lighting unit (200B,200C), and/or (iii) selection of a specific “second lighting unit” (200B,200C) upon which the user wishes to replicate the lighting characteristics of the first lighting unit (200A) represented by the captured image data. It should be noted that reference to the “second lighting unit” may also include the “first lighting unit” (200A) as it may be the case that a user may wish to store output lighting characteristics of the first lighting unit (200A) and then replicate substantially the same output lighting characteristics on the same lighting device again in future without the inconvenience of having to entirely manually adjust the lighting unit settings again.

A controller module (310) is operably connected to the touchscreen electronic display module (340) and configured to read the entered user inputs, and responsive to the received user inputs, control any one of the lighting units (200A,200B,200C) to function according to the received user inputs. In particular, the controller module (310), is configured such that, when a user selects an image of the output lighting characteristic of the first lighting unit (200A) displayed on the touchscreen electronic display module (340), the controller module (310) is configured to operate a second lighting unit (200B,200C) (also, selected by the user via the touchscreen electronic display module (340)) whereby the controller module (310) instructs the second lighting unit (200A,200B,200C) to operate in accordance with lighting unit settings represented by the associated lighting unit settings data of the first lighting unit (200A) stored in the data store module (320).

The system further comprises a communication module (330) via which the mobile electronic device (300) is able to communicate with external devices such as the various lighting units (200A,200B,200C). The communications module (330) includes a WI-FI sub-module configured for communication via a WI-FI router (800) with WI-FI transceivers in each of the lighting units (200A,200B,200C).

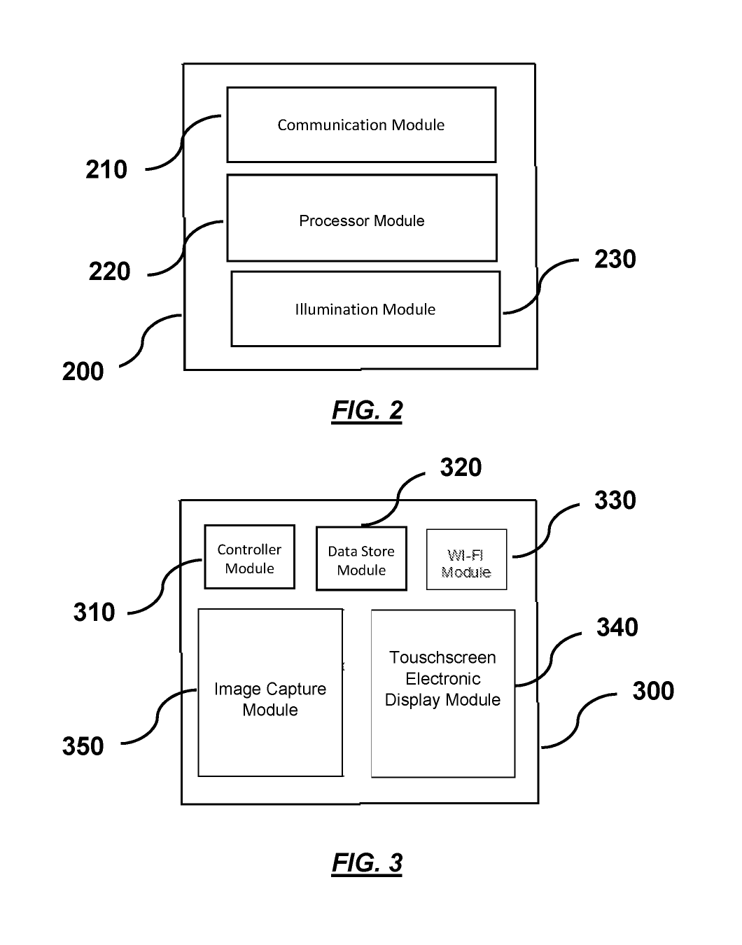

Referring to FIG. 2, a functional block diagram of an exemplary lighting unit configuration is shown (e.g. as embodied by each of the lighting units (200A, 200B, 200C) shown in FIG. 4) which comprises an illumination module (230) for outputting lighting characteristics therefrom, a Wi-Fi communication module (210) for wireless communication with external devices such as the mobile electronic device (300) via the Wi-Fi router (800), and a processor module (220) for processing basic functions of the respective lighting units (200A, 200B, 200C) as well as for operating the respective illumination modules (230). The illumination module (230) may comprise of any suitable type of lighting technology however in this embodiment comprises an LED lighting module configured to output a range of lighting characteristics including for instance varying colours and brightness characteristics in response to user selection of such lighting settings via the touchscreen electronic display module (340). Each of the lighting units (200A, 200B, 200C) may also contain a unique identifier stored in the controller module (220) that is automatically readable by the mobile electronic device (300) so as to identity each of the lighting units (200A, 200B, 200C) including the type, make and model of each lighting unit (200A,200B,200C).

A software application module is downloadable into the memory module (320) of the mobile electronic device (300) from an online computer server via the communication network and is executable by the controller module (310) of the mobile electronic device (300) to provide a graphical user-interface (340) operable on the touchscreen electronic display module (340) via which a user may be able to at least provide various user-interactive control. It would be understood that in alternate embodiments of the present invention the various user-interactive control provided by the software application module may be implemented by embedded software disposed in the hardware itself or any other suitable hardware technology.

The software application module is further configured to allow operable connection with each of the lighting units (200A,200B,200C) in the communication network via respective communication modules (210) of each of the lighting units (200A,200B,200C), to recognise each of the lighting units by reference to their respective unique identifiers, and to control operation of each of the lighting unit settings of each of the lighting units (200A,200B,200C).

The software application module is further configured to allow user operation of the image capture module (350) of the mobile electronic device (300) to capture the image of the lighting characteristics of the first lighting unit (200A). This step is represented by block 100 in FIG. 1.

The software application module is further configured to store the captured image in the memory module (320) of the system together with associated lighting unit settings data representing lighting unit settings of the first lighting unit (200A) that produced the output lighting characteristic of the first lighting unit represented by the captured image data. The associated lighting unit settings data may be obtained directly from the first light unit (200A), for instance, by the controller module (310) communicating with the processor module (220) of the first light unit (200A) to obtain such information. Alternately, the lighting unit settings data of the first lighting unit (200A) may be synchronised to multiple devices operably connected with the first lighting unit (200A) via the communication network and such associated lighting unit settings data may thereby be obtainable from multiple sources in the network. This step is represented by block 110 in FIG. 1.

The image represented by the captured image data is able to be displayed on the touchscreen electronic display module (340) as a menu item that may be selectable by the user by way of suitable user interaction with the touchscreen electronic display module (or by way of voice activation control, keyboard, mouse, or, any other suitable input means), and whereby, upon selection, the software application module is configured to communicate with the processor module (220) of a second lighting unit (200B,200C) to effect output of the lighting characteristics represented by the associated lighting unit settings data. These steps are represented by blocks 120 and 130 in FIG. 1.

The software application module is further configured to effect additional manual adjustments to the lighting unit settings of the second lighting unit (200B,200C) if so required to tweak the output lighting characteristics of the second lighting unit (200B,200C). That is, the software application module may provide a user control interface to further manually adjust colour, brightness and the like of the second lighting unit (200B,200C).

The software application module is further configured to enable synchronisation of captured image data and associated lighting unit settings data with other mobile electronic devices running the same software application module.

Also in this embodiment, multiple images may be captured of one or more first lighting units (200A) and stored in the memory module (320) with associated lighting unit settings data. The multiple images may thereafter be displayable on the touchscreen electronic display module (340) of the mobile electronic device (300) as multiple menu options so that a range of different output lighting characteristics may be selectable by the user for replication upon a second lighting unit (200B,200C) (or replicated again in future on the same first lighting unit (200A))

In this embodiment, captured image datas representing images of the first lighting units are synchronisable and/or sharable across multiple mobile electronic devices whereby such images may be displayable upon respective touchscreen electronic display modules (340) of each mobile electronic device so as to be selectable by different users in order to relatively quickly and easily replicate the output lighting characteristics represented by the various selectable images on to selected lighting units in the network selected by the users.

In certain embodiments, the software application module may also allow users to customise information displayable with the image on the touchscreen electronic display module. Such information may include a title of the captured image, or information relating of the type and/or model of the first lighting unit (200A). The software application module may also allow the user to substitute display a static image or video images on the touchscreen electronic display module

Those skilled in the art will appreciate that the invention described herein is susceptible to variations and modifications other than those specifically described without departing from the scope of the invention. All such variations and modification which become apparent to persons skilled in the art, should be considered to fall within the spirit and scope of the invention as broadly hereinbefore described. It is to be understood that the invention includes all such variations and modifications. The invention also includes all of the steps and features, referred or indicated in the specification, individually or collectively, and any and all combinations of any two or more of said steps or features.

The reference to any prior art in this specification is not, and should not be taken as, an acknowledgment or any form of suggestion that that prior art forms part of the common general knowledge.

1. A device for controlling operation of lighting units including:
an image capture module for capturing image data representing an output lighting characteristic of at least a first lighting unit;
at least one data store module operably connected with the image capture module for storing the captured image data and an associated lighting unit settings data, said associated lighting unit settings data being indicative of lighting unit settings of the first lighting unit for producing the output lighting characteristic of the first lighting unit represented by the captured image data;
an electronic display module for displaying an image of the output lighting characteristic of the at least one first lighting unit represented by the captured image data; and
an input module for receiving an input indicative of a selection relating to the image of the output lighting characteristic of the at least one first lighting unit displayed on the electronic display module, whereby responsive to the selection, a controller module is configured for operating a second lighting unit with reference to the associated lighting unit settings data whereby the second lighting unit substantially outputs the output lighting characteristic of the first lighting unit represented by the captured image data.

2. A device as claimed in claim 1 wherein the image includes at least one of a static image or video images.

3. A device as claimed in claim 1 wherein the first and second lighting units are the same.

4. A device as claimed in claim 1 wherein the device includes a mobile electronic device.

5. A device as claimed in claim 4 wherein the mobile electronic device includes at least one of a mobile smartphone, a table and a portable computer.

6. A device as claimed in claim 1 wherein the electronic display module is configured to display a plurality of images of captured output lighting characteristics of first lighting units represented by a plurality of corresponding captured images datas, said input module being configured for receiving an input indicative of a selection relating to any one of the plurality of images displayed on the electronic display module, whereby responsive to the selection, the controller module is configured for operating the second lighting unit with reference to lighting unit settings data associated with image data corresponding to the selected image, whereby the second lighting unit substantially outputs the output lighting characteristic of the first lighting unit represented by the image data corresponding to the selected image.

7. A device as claimed in claim 6 wherein the plurality of corresponding image datas representing the plurality of corresponding images of captured output lighting characteristics of first lighting units, are synchronised across multiple electronic devices via a communication network.

8. A device as claimed in claim 1 wherein the controller module is configured for operating the second lighting unit via a wireless communication network.

9. A device as claimed in claim 8 wherein the wireless communication network includes a Wi-Fi protocol compatible network.

10. A device as claimed in claim 1 wherein the input module is configured to allow a user to customise information displayable with the image on the electronic display module, the information including a title of the image.

11. A device as claimed in claim 1 wherein the output lighting characteristic of at least a first lighting unit includes at least one of:
i. a colour characteristic;
ii. a brightness characteristic;
iii. a white light colour temperature;
iv. an infrared radiation characteristic; and
v. a timing characteristic for the output of at least one of (i)-(iv).

12. (canceled)

13. A method of controlling operation of lighting units, said method including steps of:
(i) capturing via an image capture module, image data representing an output lighting characteristic of at least a first lighting unit;
(ii) storing in at least one data store module, the captured image data and an associated lighting unit settings data, said associated lighting unit settings data being indicative of lighting unit settings of the first lighting unit for producing the output lighting characteristic of the first lighting unit represented by the captured image data;
(iii) displaying via an electronic display module, an image of the output lighting characteristic of the at least one first lighting unit represented by the captured image data; and
(iv) receiving via an input module, an input indicative of a selection relating to the image of the output lighting characteristic of the at least one first lighting unit displayed on the electronic display module, whereby responsive to the selection, a controller module is configured for operating a second lighting unit with reference to the associated lighting unit settings data whereby the second lighting unit substantially outputs the output lighting characteristic of the first lighting unit represented by the captured image data.

14. A method as claimed in claim 13 wherein the image includes at least one of a static image and video images.

15. A method as claimed in claim 13 wherein the first and second lighting units are the same.

16. A method as claimed in claim 13 wherein the method is performed using a mobile electronic device.

17. A method as claimed in claim 16 wherein the mobile electronic device includes at least one of a mobile smartphone, a table and a portable computer.

18. A method as claimed in claim 13 wherein the electronic display module is configured to display a plurality of images of captured output lighting characteristics of first lighting units represented by a plurality of corresponding captured images datas, said input module being configured for receiving an input indicative of a selection relating to any one of the plurality of images displayed on the electronic display module, whereby responsive to the selection, the controller module is configured for operating the second lighting unit with reference to lighting unit settings data associated with image data corresponding to the selected image, whereby the second lighting unit substantially outputs the output lighting characteristic of the first lighting unit represented by the image data corresponding to the selected image.

19. A method as claimed in claim 18 wherein the plurality of corresponding image datas representing the plurality of corresponding images of captured output lighting characteristics of first lighting units, are synchronised across multiple electronic devices via a communication network.

20. A method as claimed in claim 13 wherein the controller module is configured for operating the second lighting unit via a wireless communication network.

21-22. (canceled)

23. A method as claimed in claim 13 wherein the output lighting characteristic of the at least a first lighting unit includes at least one of:
i. a colour characteristic;
ii. a brightness characteristic;
iii. a white light colour temperature;
iv. an infrared radiation characteristic; and
v. a timing characteristic for the output of at least one of (i)-(iv).

24-36. (canceled)
